(19) United States
(12) Patent Application Publication
(10) Pub. No.: US 2022/0400702 A1
(43) Pub. Date: Dec. 22, 2022

(54) MINCED MEAT ANALOGUE

(71) Applicant: Conopco Inc., d/b/a UNILEVER, Englewood Cliffs, NJ (US)

(72) Inventors: Paul Bom, Breda (NL); Michel Mellema, Wageningen (NL)

(73) Assignee: Conopco Inc., d/b/a UNILEVER, Englewood Cliffs, NJ (US)

(21) Appl. No.: 17/770,305

(22) PCT Filed: Oct. 20, 2020
(86) PCT No.: PCT/EP2020/079428

§ 371 Date: Apr. 20, 2022

(30) Foreign Application Priority Data
Oct. 21, 2019 (EP) 19204310.7
Oct. 21, 2019 (EP) 19204323.0
Oct. 21, 2019 (EP) 19204338.8
Oct. 21, 2019 (EP) 19204353.7

(51) Int. Cl. A23J 3/22; A23J 3/14; A23L 5/10

(52) U.S. Cl. CPC A23J 3/227; A23J 3/14; A23L 5/11; A23L 5/15; A23V 2002/00

(57) ABSTRACT

The invention relates to minced meat analogue comprising the following components:
(a) 30-80% by weight of the minced meat analogue of hydrated textured vegetable protein (TVP) pieces;
(b) 20-45% by weight of the minced meat analogue of a binder emulsion containing the following ingredients:
   (b1) 8-50% by weight of the binder emulsion of liquid oil having a saturated fatty acid content of less than 30 wt. %
   (b2) 8-50% by weight of the binder emulsion of particles of solid fat having a saturated fatty acid content of more than 50 wt.;
   (b3) 25-70% by weight of the binder emulsion of water;
   wherein the combination of ingredients (b1), (b2) and (b3) constitutes at least 70 wt. % of the binder emulsion;
      wherein the combination of components (a) to (b) constitutes at least 80 wt. % of the minced meat analogue.

### FIELD OF THE INVENTION

The present invention relates to a minced meat analogue, to a method of preparing such a minced meat analogue for consumption and to a process of producing such a meat analogue. Examples of minced meat analogues according to the present invention include vegetarian ground meat as well as vegetarian ground meat formed into patties (e.g. vegetarian hamburgers) or balls (e.g. vegetarian meat balls).

### BACKGROUND OF THE INVENTION

A burger (or hamburger) is a cooked patty of minced (or ground) meat, usually beef, that is typically placed inside a sliced bread roll or bun. The patty may be fried or grilled. Hamburgers are often served with cheese, lettuce, tomato, onion, pickles, bacon, or chili; condiments such as ketchup, mayonnaise, mustard, relish, or “special sauce”; and are frequently placed on sesame seed buns.

Since the term “burger” usually implies beef, for clarity “burger” may be prefixed with the type of meat or meat substitute used, as in beef burger, turkey burger, chicken burger, fish burger or veggie burger.

A veggie burger (or vegetarian burger) is a burger patty that does not contain meat.

These burgers may be made from ingredients like beans, especially soybeans and tofu, nuts, grains, seeds, algae or fungi such as mushrooms or mycoprotein.

### SUMMARY OF THE INVENTION

The inventors have developed a minced meat analogue that can be cooked in the same way as ordinary minced meat to produce a cooked minced meat analogue that in terms of eating quality and appearance is very similar to meat-based reference products. The minced meat analogue of the present invention is easy to manufacture and can be stored in frozen form until it is prepared for consumption.

A first aspect of the invention relates to minced meat analogue comprising the following components:
(a) 30-80% by weight of the minced meat analogue of hydrated textured vegetable protein (TVP) pieces;
(b) 20-45% by weight of the minced meat analogue of a binder emulsion containing the following ingredients:
   (b1) 8-50% by weight of the binder emulsion of liquid oil having a saturated fatty acid content of less than 30 wt. %
   (b2) 8-50% by weight of the binder emulsion of particles of solid fat having a saturated fatty acid content of more than 50 wt.; whereby preferably at least 80 wt. % of the particles of solid fat in the binder emulsion have a particle size, as determined by laser diffraction, of in the range of 30-350 μm.
   (b3) 25-70% by weight of the binder emulsion of water;
   wherein the combination of ingredients (b1), (b2) and (b3) constitutes at least 70 wt. %, preferably at least 80 wt. % of the binder emulsion;
      wherein the combination of components (a) to (b) constitutes at least 80 wt. %, preferably at least 90 wt. % of the minced meat analogue and preferably the protein content of the minced meat analogue lies in the range of 10-20%, more preferably in the range of 12-18% by weight of the minced meat analogue.

The minced meat analogue of the present invention comprises TVP pieces and a binder emulsion that contains water, oil and fat particles. The binder emulsion can act as a lubricant and a glue that allows for the preparation of a coherent dough that can be pumped and shaped into a patty or a ball and does not fall apart during storage, handling and preparation. In addition, the binder emulsion has a major impact on the eating quality of the cooked minced meat analogue as it affects important quality attributes such as succulence, bite, oily mouthfeel and in-mouth flavour release.

Unlike known the minced meat analogues, the minced meat analogue of the present invention contains liquid oil and solid fat as separate components. In the preparation of meat analogues it is common practice to thoroughly blend liquid oil with molten solid fat before combining it with other food ingredients at a temperature above the melting point of the fat blend, so that upon cooling of the product mixture the solid fat can form a crystalline matrix that prevents oil exudation. This phenomenon is also used to avoid oil separation in margarines and shortenings.

The inventors have unexpectedly discovered that solid fat particles and liquid oil can be applied in the binder emulsion of the present minced meat analogue in the amounts indicated above, without causing significant oil exudation. In addition, it was found that the presence of both liquid oil and solid fat in the binding emulsion enables the preparation of the minced meat analogue at ambient or below ambient temperatures as both the fat particles and the liquid oil can easily be dispersed throughout the product mass during mixing. In contrast thereto, a blend of solid fat and liquid oil cannot easily be dispersed as such a blend is a semi-solid mass at ambient temperature. In order to disperse such a semi-solid mass, high shear conditions need to be applied that have an adverse effect on the structure of the minced meat analogue. An important advantage associated with the preparation of the minced meat analogue at near ambient temperature resides in the fact that oxidation of the unsaturated fatty acids in the liquid oil is effectively minimised.

A second aspect of the invention relates to a method of preparing the aforementioned minced meat analogue for consumption, said method comprising frying or grilling said minced meat analogue.

A third aspect of the invention relates to a process of preparing a minced meat analogue, said process comprising:
mixing textured vegetable protein (TVP) particles with water to produce hydrated TVP pieces;
mixing the hydrated TVP pieces with water, solid fat powder and liquid oil to produce a vegetarian dough whilst maintaining the temperature of the mixture below the melting point of the solid fat.

### DETAILED DESCRIPTION OF THE INVENTION

The words ‘comprising’ and ‘containing’ as used herein should not be interpreted restrictively as meaning ‘consisting of’. In other words, besides the features listed after these words, non-listed features may be present.

Unless specified otherwise, numerical ranges expressed in the format ‘from x to y’ or ‘x-y’ are understood to include x and y. When for a specific feature multiple preferred ranges are described in the format ‘from x to y’ or ‘x-y’, it is understood that all ranges combining the different endpoints are also contemplated. For the purpose of the invention ambient temperature is defined as a temperature of about 20° C.

Unless indicated otherwise, weight percentages (wt. %) are based on the total weight of the composition. Also, unless indicated otherwise, weight percentages as based on wet weight.

The term “water content” as used herein, unless indicated otherwise, relates to the total water content.

The term “minced meat analogue” as used herein refers to a vegetarian product that has an appearance and structure similar to that of minced meat. More particularly, like minced meat, the minced meat analogue of the present invention is largely (≥50 wt. %) composed of small pieces of elastic material that are wetted on the outside by an aqueous liquid. The term “minced meat analogue” also encompasses products shaped from such minced meat analogue, such as patties and balls.

The term “textured or texturized vegetable protein (TVP)” as used herein refers to a food ingredient made from edible protein sources and characterised by having structural integrity and identifiable texture such that each unit will withstand hydration in cooking and other procedures used in preparing the food for consumption. TVP is typically produced by extrusion.

The terms “oil” and “fat” as used herein refer to a glyceride component that contains at least 80 wt. % of glycerides selected from triglycerides, diglycerides and combinations thereof.

The term “liquid oil” as used herein refers to an oil that contains no solid at 20° C. (N₂₀=0%). The solid fat content at 20° C. can be determined using ISO method ISO 8292-2:2008.

The term “solid fat” as used herein refers to a fat that contains at least 20% solid fat at 20° C. (N₂₀≥20%).

The term “non-denatured” as used herein in relation to proteins refers to proteins that still have the secondary structure which is present in their native state.

The term “dry matter” as used herein refers to the matter that remains after water and other volatile components have been removed by evaporation using a forced-air oven (2 hours at 103° C., or longer if not all moisture has been removed).

The liquid oil and the solid fat particles are present in the minced meat analogue as separate components. A fraction of the solid fat particles may be captured as distinguishable fat particles in droplets of liquid oil, thereby reducing the liquidity of these oil droplets.

Besides the hydrated TVP pieces and the binder emulsion the minced meat analogue may contain other ingredients in the form of particulate material having a particle weight of at least 1 mg. Pieces of vegetable or spices are an example of such a particulate material.

The minced meat analogue of the present invention is preferably uncooked, allowing local preparation of the cooked minced meat analogue using conventional cooking techniques such as grilling and frying. Here “uncooked” means that the complete minced meat analogue, i.e. the minced meat analogue as whole, has not been heated to temperatures in excess of 60° C. Ingredients of the minced meat analogue, such as the TVP pieces, however, may have been heated to temperatures in excess of 60° C. during the production thereof.

In another advantageous embodiment, the minced meat analogue is frozen. More preferably the minced meat analogue is a frozen uncooked minced meat analogue. Most preferably, the minced meat analogue is frozen uncooked minced meat analogue shaped in the form of a patty or a ball. Frozen distribution and storage offers the advantage that, especially when the minced meat analogue is uncooked, the product can be stored for a long time until it is prepared for consumption. The ‘meaty’ character of the minced meat analogue of the present invention is well retained during frozen storage.

The minced meat analogue of the present invention may contain animal products other than meat, such as egg and dairy products.

According to a preferred embodiment, the minced meat analogue is shaped, e.g. in the form of a patty or a ball.

The shaped minced meat analogue preferably has an open structure, i.e. the interior of the shaped product comprises small spaces that are filled with air.

According to a particularly preferred embodiment, the minced meat analogue is shaped in the form of a patty having a weight of 60-200 grams, more preferably of 90-140 grams. Preferably, the patty has an average diameter in the range of 80-150 mm and an average height in the range of 5-15 mm.

The water content of the minced meat analogue typically lies in the range of 50-70%, more preferably in the range of 55-65% by weight of the minced meat analogue.

The protein content of the minced meat analogue preferably lies in the range of 10-20%, more preferably in the range of 12-18% by weight of the minced meat analogue.

Preferably, at least 70 wt. %, more preferably at least 80 wt. % of the total amount of protein of the minced meat analogue is plant protein selected from soy protein, legume protein, wheat protein, rice protein and combinations thereof. Examples of legume proteins that can be used include lentil protein, pea protein, fababean protein, lupin protein and combinations thereof.

According to a particularly preferred embodiment, at least 50 wt. %, more preferably at least 60 wt. % and most preferably at least 75 wt. % of the total amount of protein of the minced meat analogue is soy protein.

The total fat content of the minced meat analogue preferably lies in the range of 8-22%, more preferably in the range of 10-20% by weight of the minced meat analogue.

The total amount of fat contained in the minced meat analogue typically has the following fatty acid composition:

20-40 wt. % palmitic acid;
0-20 wt. % stearic acid;
12-60 wt. % oleic acid;
10-50 wt. % polyunsaturated fatty acid;
wherein the total amount of saturated fatty acids does not exceed 50 wt. %. The fatty acid composition of the fat can be determined using ISO method 12966-4: 2015.

The minced meat analogue preferably contains 1-5%, more preferably 1.5-3.5% by weight of the minced meat analogue of dietary fiber.

Calculated by weight of the dry matter of the minced meat analogue, the minced meat analogue preferably contains 3-15 wt. %, most preferably 4-9 wt. % of dietary fiber.

Carbohydrates are preferably contained in the minced meat analogue in a concentration of 1-8%, more preferably 2-6% by weight of the minced meat analogue of carbohydrates.

Calculated by weight of the dry matter of the minced meat analogue, the minced meat analogue preferably contains 2-20 wt. %, most preferably 4-15 wt. % of carbohydrates.

The starch content of the minced meat analogue, calculated by weight of the dry matter of the minced meat analogue, preferably lies in the range of 2-18 wt. %, more preferably in the range of 3-14 wt. %.

Preferably, the minced meat analogue contains, calculated by weight of the dry matter of the minced meat analogue, 0-4% sugars, most preferably 0-2% sugars.

The minced meat analogue of the present invention preferably contains 0.2-3%, more preferably 0.3-2 salt by weight of the minced meat analogue. Here the term salt refers to sodium chloride, potassium chloride and combinations thereof.

The pH of the minced meat analogue preferably lies in the range of pH 5 to pH 7.5, more preferably in the range of pH 5.8 to pH 6.8.

In a preferred embodiment, the minced meat analogue contains 40-75%, more preferably 50-72% by weight of the minced meat analogue of the hydrated TVP pieces.

The hydrated TVP pieces can be prepared by soaking dry TVP particles with water. Dry TVP particles are commercially available. These dry TVP particles are typically produced by extrusion cooking and drying.

The hydrated TVP pieces in the minced meat analogue typically have a water content of at least 50%, more preferably of 60-78% by weight of the hydrated TVP pieces.

Protein is preferably contained in the hydrated TVP pieces in a concentration, calculated by weight of the dry matter of the hydrate TVP pieces, of at least 50 wt. %, more preferably of at least 60 wt. %, most preferably of at least 62 wt. %.

The hydrated TVP pieces present in the minced meat analogue can have different shapes, such as sphere-like, fiber-like and sheet-like.

The hydrated TVP pieces in the minced meat analogue typically contain, calculated by weight of the dry matter of the hydrated TVP pieces, 50-80 wt. % protein, 0-5 wt. % fat and 3-30 wt. % dietary fiber. More preferably, the hydrated TVP pieces in the minced meat analogue contain, calculated by weight of the dry matter of the hydrated TVP pieces, 65-75 wt. % protein, 0.5-4 wt. % fat and 6-24 wt. % dietary fiber.

Preferably, at least 80 wt. %, more preferably at least 90 wt. % of the total amount of protein of the hydrated TVP pieces is plant protein selected from soy protein, legume protein, wheat protein, rice protein and combinations thereof. Examples of legume proteins that can be used include lentil protein, pea protein, fababean protein, lupin protein and combinations thereof.

In a more preferred embodiment, at least 80 wt. %, more preferably at least 90 wt. % and most preferably at least 95 wt. % of the total amount of protein of the hydrated TVP pieces is protein selected from soy protein, pea protein, gluten and combinations thereof.

According to a particularly preferred embodiment, at least 70 wt. %, more preferably at least 80 wt. %, most preferably at least 85 wt. % of the total amount of protein of the hydrated TVP pieces is soy protein.

The minced meat analogue preferably comprises 18-48%, more preferably 20-45% and most preferably 25-42% by weight of the minced meat analogue, of the binder emulsion containing water, liquid oil and solid fat particles.

The water content of the binder emulsion preferably lies in the range of 28-60%, more preferably in the range of 30-50% by weight of the binder emulsion.

According to a preferred embodiment, the binder emulsion contains 1-15%, more preferably 2-12% and most preferably 3-10% by weight of the binder emulsion of a heat-gelling binder selected from non-denatured patatin, non-denatured glycinin, non-denatured legumin, non-denatured egg protein, methyl cellulose and combinations thereof. The application of the heat-gelling binder in the binder emulsion offers the advantage that a firm product can be made that will withstand handling, that can easily be shaped/moulded and that provides a pleasant bite upon consumption.

The heat-gelling binder of the binder emulsion advantageously includes methyl cellulose. Preferably, the binder emulsion contains 1-12%, more preferably 2-10% and most preferably 3.0-8.0% by weight of the binder emulsion of methyl cellulose.

The minced meat analogue preferably contains, calculated by weight of the dry matter of the minced meat analogue, 2.5-10 wt. %, more preferably 3.0-9.0 wt. %, most preferably 5.0-8.0 wt. % of methyl cellulose.

The methyl cellulose employed in accordance with the present invention preferably has a methoxyl content of 20% to 40%, more preferably of 24% to 36%.

In another preferred embodiment, the methyl cellulose employed has a viscosity at a temperature of 20° C. and a concentration of 2 wt. % in water of 20,000-1,000,000 cP, more preferably of 30,000-500,000 cP and most preferably of 35,000-200,000 cP.

The molecular weight of the methyl cellulose preferably lies in the range of 100 to 250 kDa, more preferably in the range of 150 to 220 kDa.

According to a preferred embodiment, the methyl cellulose has a gelation temperature of at least 30° C., more preferably a gelation temperature in the range of 35° C. to 60° C., most preferably a gelation temperature in the range of 40° C. to 50° C.

According to another preferred embodiment, the binder emulsion contains 0.3-8%, more preferably 0.5-6% and most preferably 0.6-4% by weight of the binder emulsion of non-denatured plant protein selected from non-denatured patatin, non-denatured glycinin, non-denatured legumin, and combinations thereof.

Methyl cellulose and non-denatured plant protein, selected from non-denatured patatin, non-denatured glycinin, non-denatured legumin, and combinations thereof, are typically present in the minced meat analogue in a weight ratio of 1:1 to 8:1. More preferably, methyl cellulose and the non-denatured plant protein are present in the minced meat analogue in a weight ratio of 3:2 to 6:1.

The water content of the binder emulsion preferably lies in the range of 28-65%, more preferably of 32-60% by weight of the binder emulsion.

The fat content of the binder emulsion preferably lies in the range of 30-68%, more preferably of 35-65% by weight of the binder emulsion.

The binder emulsion preferably contains 10-40%, more preferably 12-30% by weight of the binder emulsion of the liquid oil.

The binder emulsion preferably contains 10-40%, more preferably 15-32% by weight of the binder emulsion of the particles of solid fat.

According to a particularly preferred embodiment, the fat that is contained in the binder emulsion comprises, calculated by weight of said fat, (i) 25-75 wt. % liquid oil having a saturated fatty acid content of less than 30 wt. % and (ii) 25-75 wt. % particles of solid fat having a saturated fatty acid content of more than 50 wt. %. Even more preferably, the fat of the binder emulsion comprises, calculated by weight of said fat, (i) 30-60 wt. % of the liquid oil and (ii) 40-70 wt. % of the particles of solid fat.

The combination of the liquid oil and the particles of solid fat preferably constitutes at least 80 wt. %, more preferably at least 90 wt. % and most preferably at least 95 wt. % of the fat of the binder emulsion.

The liquid oil preferably contains less than 25 wt. %, more preferably less than 20 wt. % saturated fatty acids.

Preferably, the liquid oil contains at least 30 wt. % of polyunsaturated fatty acids, more preferably at least 50 wt. % of polyunsaturated fatty acids.

The liquid oil is preferably selected from sunflower oil, soybean oil, rapeseed oil, cottonseed oil, safflower oil, olive oil, linseed oil, corn oil and combinations thereof.

The solid fat present in the particles of solid fat is preferably selected from palm stearin, palm mid fraction, hydrogenated vegetable oils and combinations thereof. Most preferably, the solid fat is selected from palm stearin, palm mid fraction and combinations thereof.

The solid fat in the particles of solid fat preferably has a solid fat content at 30° C. of at least 25%, more preferably of at least 30% as determined using ISO method 8292-1:2008.

The solid fat in the particles of solid fat typically has a slip melting point of at least 45° C., more preferably a slip melting point of at least 48° C. as determined using ISO method 6321:2002.

The liquid oil and the particles of solid fat are preferably present in the binder emulsion in a weight ratio that lies in the range of 1:3 to 3:1, more preferably in the range of 1:2 to 2:1.

The combined total amount of liquid oil and particles of solid fat typically constitutes 25-70% by weight, more preferably 30-60% by weight of the binder emulsion.

In accordance with a preferred embodiment, at least 80 wt. % of the particles of solid fat in the binder emulsion have a particle size, as determined by laser diffraction, of in the range of 30-350 μm.

Preferably, the minced meat analogue comprises added caramelised material selected from caramel, burnt sugar, malt extract and combinations thereof. More preferably, the minced meat analogue comprises 0.01-1%, by weight of the minced meat analogue of the caramelized material.

The term “caramel” as used herein, unless indicated otherwise, refers to a water-soluble food colouring that is made by heating carbohydrates either alone or in the presence of acids, alkalis, and/or salts. Carbohydrates used the commercial production of caramel colouring include fructose, glucose, invert sugar, sucrose, malt syrup, molasses, starch hydrolysates, and fractions thereof. The acids that may be used are sulfuric, sulfurous, phosphoric, acetic, and citric acids; the alkalis are ammonium, sodium, potassium, and calcium hydroxides; and the salts are ammonium, sodium, and potassium carbonate, bicarbonate, phosphate (including mono- and dibasic), sulfate, and bisulfite. Internationally, the United Nations Joint Food and Agriculture Organization/World Health Organization Expert Committee on Food Additives (JECFA) recognizes four classes of caramel colour, differing by the reactants used in their manufacture, each with its own INS and E number:

| Class | INS/E number | Description |
|---|---|---|
| I | 150a/E 150a | Plain caramel |
| II | 150b/E 150b | Caustic sulfite caramel |
| III | 150c/E 150c | Ammonia caramel |
| IV | 150d/E 150d | Sulfite ammonia caramel |

The term “burnt sugar” as used herein refers to caramalised sugar, also known as “caramel sugar”, that has been produced by heating sugar without the use of chemical reactants that are used in the production of the above mentioned caramel colourings.

The caramelised material applied in the minced meat analogue preferably is caramel, burnt sugar or a combination thereof. According to a particularly preferred embodiment, the caramel material employed in the binder suspension is burnt sugar. Typically, the burnt sugar has a sugar content of at least 80 wt. %, more preferably of at least 90 wt. %, calculated by weight of the burnt sugar.

According to a particularly preferred embodiment, the minced meat analogue contains vegetable carbon. Here, the term “vegetable carbon” refers to particles of carbonized vegetable material. According to a preferred embodiment, the vegetable carbon is a form of finely divided carbon produced by steam activation of carbonized raw material of vegetable origin that has been assigned E number E 153. Preferably, the minced meat analogue contains 0.01-0.3%, more preferably 0.02-0.2% by weight of the minced meat analogue of vegetable carbon.

According to a particularly preferred embodiment, the vegetable carbon is contained in the binder emulsion.

Preferably, not more than 20 wt. %, more preferably not more than 10 wt. % of the vegetable carbon of the minced meat analogue is contained within the hydrated TVP pieces.

The vegetable carbon preferably has a particle size distribution, determined by laser diffraction, that meets the following condition: at least 80 wt. % of the carbon particles has a size within the range of 0.5 and 50 μm. Vegetable carbon may suitably be introduced in the form of a suspension.

Another aspect of the invention relates to a method of preparing a minced meat analogue as described herein before for consumption, said method comprising frying or grilling said minced meat analogue.

In accordance with a particularly preferred embodiment, the minced meat analogue is shaped in the form of a patty and is prepared for consumption by frying or grilling the patty to produce a cooked patty and placing the cooked patty inside a cut bun.

Yet another aspect of the invention relates to a process of preparing a minced meat, said process comprising:
mixing textured vegetable protein (TVP) particles with water to produce hydrated TVP pieces;
mixing the hydrated TVP pieces with water, solid fat powder and liquid oil to produce a vegetarian dough whilst maintaining the temperature of the mixture below the melting point of the solid fat.

The present process of preparing a minced meat analogue preferably yields a minced meat analogue as described herein before.

Preferably, in the present process, the hydrated TVP particles and water are mixed in a weight ratio that lies in the range of 2:1 to 12:1, more preferably in the range of 3:1 to 6:1.

According to a further preferred embodiment, in the present process, the combination of solid fat powder and liquid oil is mixed with the hydrated TVP particles in a weight ratio of 1:12 to 1:2.5, more preferably in the range of 1:8 to 1:3.

The solid fat powder and liquid oil are preferably employed in the present process in a weight ratio of 1:3 to 3:1, more preferably in a weight ratio of 1:2 to 2:1.

The TVP particles employed in the present method preferably have a water content, calculated by weight of the TVP particles, of not more than 15 wt. %, more preferably of not more than 12 wt. %, most preferably of not more than 10 wt. %.

The TVP particles preferably contain, calculated by weight of the dry matter contained therein, 50-80 wt. % protein, 0-5 wt. % fat and 3-30 wt. % dietary fiber. More preferably, the TVP particles contain, calculated by weight of the dry matter that is contained therein, 65-75 wt. % protein, 0.5-4 wt. % fat and 6-24 wt. % dietary fiber.

Preferably, at least 80 wt. %, more preferably at least 90 wt. % of the total amount of protein of the TVP particles is plant protein selected from soy protein, legume protein, wheat protein, rice protein and combinations thereof. Examples of legume proteins that can be used include lentil protein, pea protein, fababean protein, lupin protein and combinations thereof.

In a more preferred embodiment, at least 80 wt. %, more preferably at least 90 wt. % and most preferably at least 95 wt. % of the total amount of protein of the TVP particles is protein selected from soy protein, pea protein, gluten and combinations thereof.

According to a particularly preferred embodiment, at least 70 wt. %, more preferably at least 80 wt. %, most preferably at least 85 wt. % of the total amount of protein of the TVP particles is soy protein.

The hydrated TVP particles are preferably prepared by mixing 1 part by weight of the TVP particles with 1.5 to 3 parts by weight of water.

The hydrated TVP pieces, liquid oil and the solid fat employed in the present process preferably are as specified herein before.

In accordance with a preferred embodiment, at least 80 wt. % of the particles of solid fat powder employed in the process has a particle size, as determined by laser diffraction, in the range of 35-350 μm.

In accordance with a preferred embodiment, the mixing of the hydrated TVP pieces with water, fat powder and liquid oil is carried out in a device that does not exert high shear conditions. Accordingly, in a preferred embodiment, a paddle mixer, a conical screw mixer or a bowl mixer is used in mixing step ii.

According to a particularly preferred embodiment, during step ii of the present process, the ingredients of the patty are kept at a temperature in the range of −5° C. to 30° C., more preferably in the range of −3° C. to 20° C., most preferably in the range of −2° C. to 16° C.

In a preferred embodiment, the mixture obtained in step ii is frozen and packaged, optionally after having been shaped, e.g. in the form of a patty or a ball.

According to a particularly preferred embodiment, the mixture obtained in step ii is shaped into patties or balls of 60-200 grams. Preferably, when shaped, the mixture obtained in step ii has a temperature in the range of −5° C. to 20° C., more preferably in the range of −3° C. to 15° C., most preferably in the range of −2° C. to 12° C.

The present invention is further illustrated by the following non-limiting examples.

### EXAMPLES

### Example 1

Vegetarian burgers according to the present invention were prepared on the basis of the recipe shown in Table 1.

TABLE 1

| | Wt. % |
|---|---|
| TVP Contex 300 ¹ | 19.14 |
| Methocel Bind 250 ² | 2.20 |
| Egg protein powder | 1.00 |
| Z-K5000 Rudinblack ³ | 0.05 |
| Pepper | 0.20 |
| Salt | 0.40 |
| Caramel sugar NCS23P ⁴ | 0.15 |
| Flavouring | 1.20 |
| JFI Palmstearin 54 LT (MB) ⁵ | 9.00 |
| Sunflower oil | 7.00 |
| Water | 59.66 |

¹ Textured vegetable protein; Solbar Ningbo Protein Technology, Ningbo, China (68 wt. % protein, 8 wt. % moisture)
² Methyl cellulose; The Dow Chemical Company
³ Vegetable Carbon (E 153); Huijbregts Groep, the Netherlands
⁴ Huijbregts Groep, the Netherlands
⁵ Palm stearin powder (melting point 51-55° C.), Juchem Food, Germany (the remaining ingredients were obtained in Europe)

The burgers were prepared on lab-scale using the following procedure:
1.914 kg of the textured vegetable protein was mixed with 2.35 kg tap water (10° C.) in a vacuum bag. This pre-determined amount of water is sufficient to fully hydrate the textured vegetable protein. The bag was sealed and stored at 7° C.;
After 1 hour of hydration at 7° C., the hydrated textured vegetable protein was introduced in a Kenwood mixer. The potato protein and the egg protein powder were added, followed by mixing for 2 minutes at low speed (speed 2);
The remainder of the water was added, followed by mixing for 20 seconds;
The vegetable carbon and the caramel sugar were added, followed by mixing for 20 seconds;
Flavouring, spices and salt were added, followed by mixing for 20 seconds;
Palm stearin powder and sunflower oil were added, followed by mixing for 20 seconds;
The dough mass so prepared was transferred into a bowl and put in a freezer to cool down to 1° C. (in 45 minutes);
The dough mass was taken out of the freezer, mixed again for 20 seconds and shaped by hand into burger patties having a diameter of 12 cm and a thickness of 1 cm, using a patty shaper’;
The patties so obtained were frozen and stored at −21° C.

### Example 2

The vegan burgers of Example 1 were prepared for consumption by pan frying. One table spoon of sunflower oil was added to a 20 cm diameter Tefal® Teflon® coated pan, which was placed on a medium heat gas stove to which the burger was added. The burger was pan fried for 4 minutes in total, 2 minutes on each side.

An expert panel (n=3) evaluated the appearance, taste and texture of the freshly prepared vegetarian burgers, using the attributes mentioned in Table 2. The vegan burger of Example 1 was compared to commercially available vegetarian burgers:
A (“Beyond Meat Burger”, El Segundo, Calif., USA),
B (“Incredible Burger”, Garden Gourmet, Nestlé, Switzerland),

The vegan burger of Example 1 was found to be superior in terms of bite, chewing granularity, off-flavour, natural colour and fried appearance. Furthermore, the vegan burger of Example 1 was clearly preferred by the panel over the commercially available vegetarian burgers.

1. A minced meat analogue comprising the following components:
(a) 30-80% by weight of the minced meat analogue of hydrated textured vegetable protein (TVP) pieces;
(b) 20-45% by weight of the minced meat analogue of a binder emulsion containing the following ingredients:
(b1) 8-50% by weight of the binder emulsion of liquid oil having a saturated fatty acid content of less than 30 wt. %
(b2) 8-50% by weight of the binder emulsion of particles of solid fat having a saturated fatty acid content of more than 50 wt. %; whereby said solid fat in the particles of solid fat has a solid fat content at 30° C. of at least 25%, determined using ISO method 8292-1:2008;
(b3) 25-70% by weight of the binder emulsion of water;
wherein the combination of ingredients (b1), (b2) and (b3) constitutes at least 70 wt. % of the binder emulsion;
wherein the combination of components (a) to (b) constitutes at least 80 wt. % of the minced meat analogue; and the protein content of the minced meat analogue lies in the range of 10-20%.

2. Minced meat analogue according to claim 1, wherein the minced meat analogue is uncooked.

3. Minced meat analogue according to claim 1, wherein the minced meat analogue contains, calculated by weight of the minced meat analogue, 12-20 wt. % protein, 8-22 wt. % fat and 50-70 wt. % water.

4. Minced meat analogue according to claim 1, wherein the TVP pieces contain, calculated by weight of the dry matter of the TVP pieces, 50-80 wt. % protein, 0.5-5 wt. % fat and 3-30 wt. % dietary fiber.

5. Minced meat analogue according to claim 1, wherein at least 80 wt. % of the total amount of protein of the TVP pieces is protein selected from soy protein, pea protein, gluten and combinations thereof.

6. Minced meat analogue according to claim 1, wherein the solid fat is selected from palm stearin, palm mid fraction, hydrogenated vegetable oils and combinations thereof.

7. Minced meat analogue according to claim 1, wherein the liquid oil and the particles of solid fat are present in the binder emulsion in a weight ratio that lies in the range of 1:3 to 3:1.

8. Minced meat analogue according to claim 1, wherein the combined total amount of liquid oil and particles of solid fat constitutes 25-70% by weight of the binder emulsion.

9. Minced meat analogue according to claim 1, wherein the binder emulsion contains 1-15% by weight of the binder emulsion of a heat-gelling binder selected from non-denatured patatin, non-denatured glycinin, non-denatured legumin, non-denatured egg protein, methyl cellulose and combinations thereof.

10. Minced meat analogue according to claim 1, wherein the minced meat analogue comprises the following components:
(a) 50-72% by weight of the minced meat analogue of hydrated TVP pieces;
(b) 25-42% by weight of the minced meat analogue of a binder emulsion containing the following ingredients:
(b1) 12-30% by weight of the binder emulsion of liquid oil having a saturated fatty acid content of less than 30 wt. %
(b2) 15-32% by weight of the binder emulsion of particles of solid fat having a saturated fatty acid content of more than 50 wt. %;
(b3) 32-60% by weight of the binder emulsion of water;
wherein the combination of ingredients (b1), (b2) and (b3) constitutes at least 80 wt. % of the binder emulsion;
wherein the combination of components (a) to (b) constitutes at least 90 wt. % of the minced meat analogue.

11. A method of preparing a minced meat analogue according to claim 1 for consumption, said method comprising frying or grilling said minced meat analogue.

12. A process of preparing a minced meat analogue according to claim 1, said process comprising:
i. mixing textured vegetable protein (TVP) particles with water to produce hydrated TVP pieces;
ii. mixing the hydrated TVP pieces with water, solid fat powder and liquid oil to produce a minced meat analogue whilst maintaining the temperature of the mixture below the melting point of the solid fat.

13. Process according to claim 12, wherein the TVP particles contain, calculated by weight of the dry matter contained therein, 50-80 wt. % protein, 0-5 wt. % fat and 3-30 wt. % dietary fiber.

14. Process according to claim 12, wherein, during step ii, the temperature of the mixture is kept within the range of −5° C. to 30° C.

15. Process according to claim 12, wherein at least 80 wt. % of the particles of solid fat powder has a particle size, as determined by laser diffraction, of in the range of 35-350 μm.

16. The minced meat analogue according to claim 1, wherein at least 80 wt. % of the particles of solid fat in the binder emulsion have a particle size, as determined by laser diffraction, of in the range of 30-350 μm.

17. Process according to claim 13, wherein the TVP particles contain, calculated by weight of the dry matter contained therein 65-75 wt. % protein, 0.5-4 wt. % fat and 6-24 wt. % dietary fiber.
